(19) United States
(12) Patent Application Publication
(10) Pub. No.: US 2026/0202013 A1
(43) Pub. Date: Jul. 16, 2026

(54) GREASE GUN INCLUDING A RELIEF VALVE AND PRESSURE MONITORING

(71) Applicant: MILWAUKEE ELECTRIC TOOL CORPORATION, Brookfield, WI (US)

(72) Inventors: Samuel J. Becker, Wauwatosa, WI (US); Ryan J. Mack, Menomonee Falls, WI (US); Arber Halimi, Hartland, WI (US); Joseph D. Kotlan, Menomonee Falls, WI (US); Muntather M. Alnasser, Sussex, WI (US); Jacob R. McDonald, Ixonia, WI (US); Suresh Natesan, Menomonee Falls, WI (US)

(21) Appl. No.: 19/445,019

(22) Filed: Jan. 9, 2026

Related U.S. Application Data
(60) Provisional application No. 63/900,746, filed on Oct. 17, 2025.
(60) Provisional application No. 63/901,085, filed on Oct. 17, 2025.
(60) Provisional application No. 63/766,652, filed on Mar. 4, 2025.
(60) Provisional application No. 63/745,971, filed on Jan. 16, 2025.

(51) Int. Cl. F16N 5/00; F16K 17/04; F16N 29/02; F16N 29/04

(52) U.S. Cl. CPC F16N 5/00; F16K 17/0406; F16N 29/02; F16N 29/04; F16N 2200/10; F16N 2250/04; F16N 2250/08; F16N 2270/62; F16N 2270/72

(57) ABSTRACT

A grease gun includes a housing; a motor assembly; a pump assembly including a plunger; canister assembly configured to provide grease to the pump assembly and including a canister defining an interior in which grease is stored; a pump housing to which the canister assembly is coupled and including a discharge path in which the plunger is at least partially supported communicating the interior of the canister with an outlet; a check valve at least partially supported downstream of the plunger; and a relief valve at least partially defining a relief path downstream of the check valve configured to convey grease from the discharge path to the canister. The relief valve is operable in a first mode, automatically opening when a pressure in the discharge path exceeds a pressure threshold, and a second mode, selectively opened allowing grease to flow from the discharge path to the canister.

### CROSS-REFERENCE TO RELATED APPLICATIONS

This application claims priority to U.S. Provisional Patent Application No. 63/901,085, filed on October 17, 2025, U.S. Provisional Patent Application No. 63/900,746, filed on October 17, 2025, U.S. Provisional Patent Application No. 63/766,652, filed on March 4, 2025, and U.S. Provisional Patent Application No. 63/745,971, filed on January 16, 2025, the entire contents of each of which are incorporated by reference herein.

### FIELD

The present disclosure relates to a grease gun and, more particularly, to a grease gun including a relief valve and pressure monitoring, and visual indication of operation of the grease gun.

### BACKGROUND

Grease guns distribute grease from a canister, typically through a hose, to a grease fitting coupled to an external assembly that requires regular replenishment of grease to continue smooth operation. For various reasons, blockages form in the fitting or hose. Continued operation of the grease gun following formation of a blockage increases the pressure in the hose and/or grease gun. Pressure above a threshold may result in rupturing of the hose, leakage at various fittings of the grease gun, or other undesirable outcomes.

A grease gun may be operable at different operating parameters such as a maximum pressure at which grease is supplied to a fitting, for instance, a low-pressure mode having a first, lower pressure threshold and a high-pressure mode having a second, higher pressure threshold. Due to the construction of the grease gun, a user may not know the pressure of the grease within the tool. Furthermore, while operating the grease gun, the grease dispensed by the grease gun is under pressure, and the user does not know the pressure of the grease gun. The user may also need to relieve the pressure of the grease in the grease gun prior to disconnecting the hose from a fitting. The user, however, may not know the pressurized status of the tool.

### SUMMARY

The present disclosure provides, in one aspect, a grease gun configured to dispense grease including: a housing; a motor assembly supported in the housing; a pump assembly driven by the motor assembly to generate a flow of grease, the pump assembly including a plunger; a canister assembly configured to provide grease to the pump assembly, the canister assembly including a canister defining an interior in which grease is stored; a pump housing supported by the housing and to which the canister assembly is coupled, the pump housing defining a discharge path in which the plunger is at least partially supported, the discharge path communicating the interior of the canister with an outlet of the discharge path; a check valve at least partially supported in the discharge path downstream of the plunger; and a relief valve at least partially defining a relief path downstream of the check valve, the relief path configured to convey grease from the discharge path to the interior of the canister, the relief valve operable in a first mode and a second mode, in the first mode the relief valve is automatically opened when a pressure in the discharge path exceeds a pressure threshold, and in the second mode, the relief valve is selectively openable to allow grease to flow from the discharge path through the relief path to the interior of the canister.

The present disclosure provides, in another aspect, a grease gun configured to expel grease including: a housing; a pump housing supported in the housing; a canister coupled to the pump housing having an interior in which a quantity of grease is stored; a motor supported in the housing; a pump assembly at least partially supported in the pump housing, the pump assembly coupled to the motor to receive an output from the motor to pump grease from the canister through a flow path to an outlet of the pump housing; a pressure sensor in fluid communication with the flow path, the pressure sensor configured to generate a pressure signal indicating a fluid pressure in the flow path; a current sensor configured to measure a current drawn by the motor and generate a current signal indicating the current; a controller configured to receive the pressure signal and the current signal and generate an indicator signal; and a display unit coupled to the housing, the display unit including an indicator light that is illuminated based on the indicator signal.

The present disclosure provides, in another aspect, a grease gun configured to expel grease including: a housing; a pump housing supported in the housing; a canister coupled to the pump housing having an interior in which a quantity of grease is stored; a motor supported in the housing; a pump assembly at least partially supported in the pump housing, the pump assembly coupled to the motor to receive an output from the motor to pump grease from the canister through a flow path to an outlet of the pump housing; a current sensor configured to measure a current drawn by the motor and generate a current signal indicating the current, the current signal indicating a pressure of the grease; a controller configured to operate the motor in a first mode and in a second mode, the controller generating an indicator signal based on the current signal; and a display unit coupled to the housing, the display unit including an indicator light that is illuminated based on the indicator signal.

Other features and aspects of the invention will become apparent by consideration of the following detailed description and accompanying drawings.

### BRIEF DESCRIPTION OF THE DRAWINGS

FIG. 1 is a perspective view of a grease gun.

FIG. 2 is a cross-sectional view of the grease gun of FIG. 1.

FIG. 3 is a cross-sectional view of a portion of the grease gun of FIG. 1.

FIG. 4 is a perspective, cross-sectional view of the portion of the grease gun of FIG. 3.

FIG. 5 is a cross-sectional view of a relief valve of the grease gun.

FIG. 6 is a cross-sectional view of another relief valve for use with the grease gun, the relief valve in a first operation mode.

FIG. 7 is a cross-sectional view of the relief valve of FIG. 6 in a second operation mode.

FIG. 8 is a cross-sectional view of a pressure sensing mechanism of the grease gun of FIG. 1.

FIG. 9 is a perspective view of another grease gun.

FIG. 10 is an enlarged, rear perspective view of the grease gun of FIG. 9.

FIG. 11 is an enlarged, front perspective view of the grease gun of FIG. 9.

FIG. 12 is a front view of the grease gun of FIG. 9.

FIG. 13 is a cross-sectional view of another relief valve for use with the grease gun.

FIG. 14 is another cross-sectional view of the relief valve of FIG. 13.

FIG. 15 is a top view of a portion of the grease gun of FIG. 1 or FIG. 11, including a display unit and an indicator light.

FIG. 16 is another top view of a portion of the grease gun of FIG. 1 or FIG. 11, including the display unit and another indicator light.

FIG. 17 is a graph of a first mode of operation of the grease gun of FIG. 1 or FIG. 11.

FIG. 18 is a graph of a second mode of operation of the grease gun of FIG. 1 or FIG. 11.

FIG. 19 is a graph of operating cases of a grease gun operated in a second mode of operation.

FIG. 20 is a graph of a motor speed at startup of a grease gun.

FIG. 21 is a graph of an operating pressure of a grease gun operating in a high pressure mode.

FIG. 22 is a graph of an operating pressure of a grease gun operating in a high pressure mode.

FIG. 23 is a graph of an operating pressure of a grease gun operating in a high flow mode.

FIG. 24 is a graph of an operating pressure of a grease gun operating in a high flow mode.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

### DETAILED DESCRIPTION

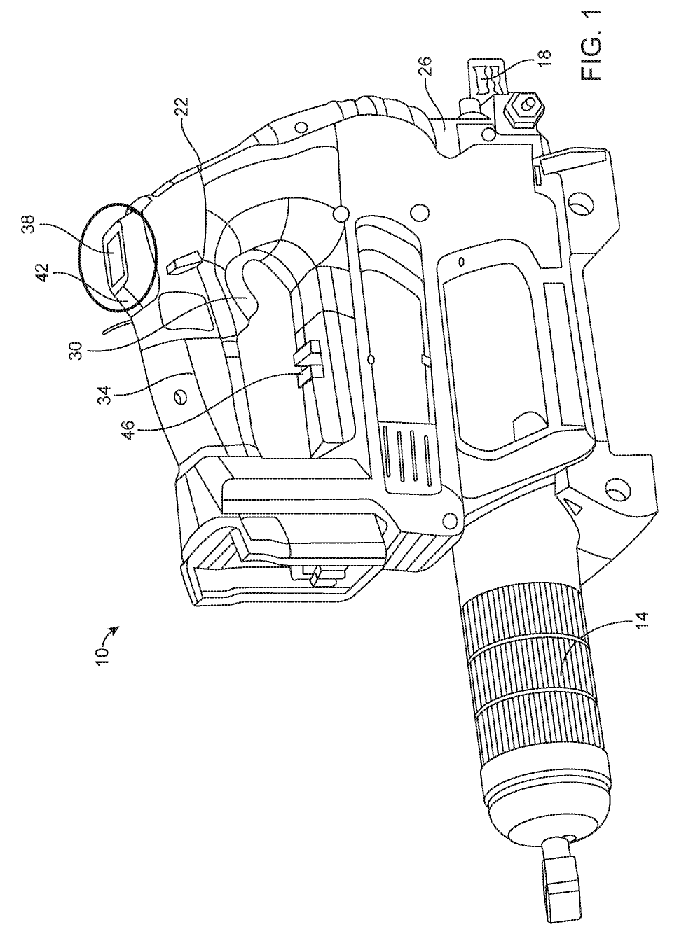

FIGS. 1-4 illustrate a grease gun 10 configured to pump grease stored in a canister assembly 14 through a hose 18 to a fitting to which the hose 18 is coupled. The grease gun 10 includes a housing 22 that supports a pump housing 26 to which the canister assembly 14 is couplable. The hose 18 is couplable to the pump housing 26 and is connectible to a fitting (not shown) that receives grease from the grease gun 10. A battery pack (e.g., a rechargeable 18-volt battery pack, a 12-volt battery pack, or a battery pack having another voltage, not shown) provides a power source for the grease gun 10. The grease gun 10 includes a trigger 30 coupled to a handle 34 of the housing 22 and configured to activate the grease gun 10. The illustrated handle 34 is a D-shaped that extends upwardly from a remainder of the housing 22. The handle 34 is positioned above the canister assembly 14 and the pump housing 26. In addition, the handle 34 includes a first or forward end adjacent the hose 18 and a second or rearward end opposite the forward end. A battery receptacle is positioned at the rearward end to receive the battery pack. The grease gun 10 also includes a display unit 38. In the illustrated embodiment, the display unit 38 is coupled to a top side 42 of the handle 34. In particular, the display unit 38 is coupled to a side or surface of the handle 34 opposite from the trigger 30. The display unit 38 is also located at the forward end of the handle 34. That is, the display unit 38 is positioned on the end of the handle 34 closest to the hose 18 and opposite from the battery receptacle. As such, the display unit 38 remains visible when a user grasps the handle 34 and operates the grease gun 10. In other embodiments, the display unit 38 may be located elsewhere on the housing 22 or the grease gun 10. The illustrated display unit 38 includes or more indicators lights configured to display a visual indication of the operational status of the grease gun 10, as will be described in further detail below. The grease gun 10 also includes a mode select interface 46 configured as a slidable switch. In other embodiments, the mode select interface 46 may be configured as a dial, a push button, etc. The mode select interface 46 is engageable by the user to select between two or more operation modes. In the illustrated embodiment, the mode select interface 46 is located on a surface of the housing 22 beneath the handle 34. In other embodiments, the mode select interface 46 may be located elsewhere on the housing 22. In the present embodiment, the grease gun 10 is operable in two modes: a first, low-pressure mode having a low-pressure threshold (e.g., 5,000 psi), and a second, high-pressure mode having a high-pressure threshold (e.g., 10,000 psi).

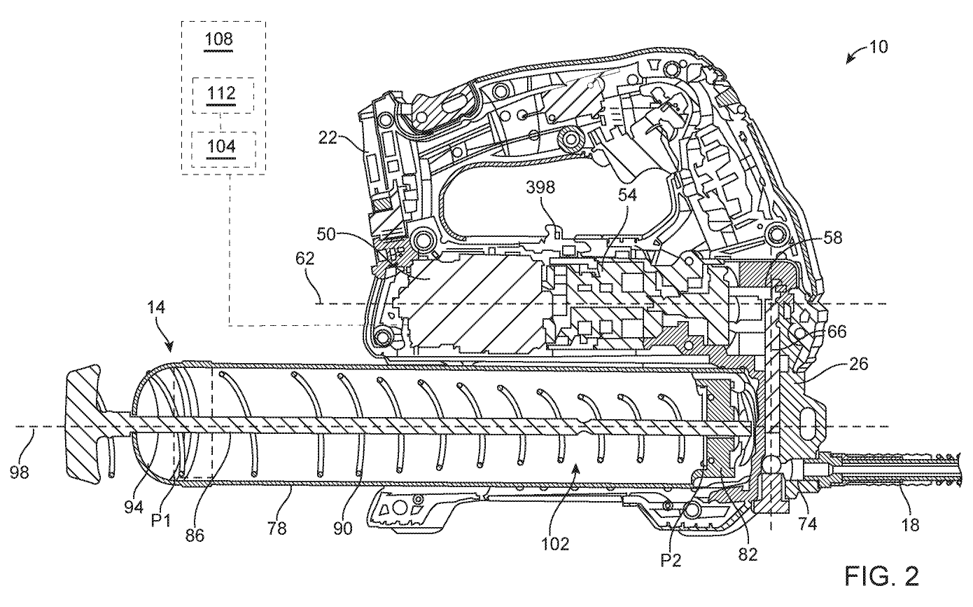

FIGS. 1-2 illustrates a grease gun 10 including a housing 22 that supports a motor assembly 50, a gear assembly 54, and a pump assembly 58. The motor assembly 50 may include, for example, a brushless DC motor. In other embodiments, the motor assembly 50 may include other types of motors, such as a brushed motor or an AC motor. The motor assembly 50 provides a rotational output about a rotation axis 62 to the gear assembly 54, which in turn provides a rotational output about the rotation axis 62 to the pump assembly 58. The gear assembly 54 may include, for example, a planetary gear assembly. In some embodiments, the planetary gear assembly may include multiple stages. In the illustrated embodiment, the planetary gear assembly includes four stages. The gear assembly 54 may be operable at multiple speeds. In the illustrated embodiment, the gear assembly 54 may be operable at two speeds. In other embodiments, the gear assembly 54 may include other components and/or configurations. The pump assembly 58 reciprocates along a pump axis 66 in response to the rotational output from the gear assembly 54. Reciprocation of the pump assembly 58 dispenses grease from a canister assembly 14 coupled to a pump housing 26. The pump housing 26 is supported by the housing 22. In some embodiments, the pump housing 26 may be supported at least partially within the housing 22. The grease is dispensed from the pump housing 26 to a hose 18 that is coupled to an outlet 74 of the pump housing 26.

The housing 22 also supports a printed circuit board assembly (PCBA) 108. The PCBA 108 includes a controller 104 and a current sensor 112. The controller 104 receives a pressure signal, current signal, mode signal, and other signals and controls operation of the grease gun 10 based on the monitored values indicated by those signals. The controller 104 also generates an indicator signal that is provided to the display unit 38 to control the visual indication provided by the indicator lights of the display unit 38. The current sensor 112 monitors the current drawn during operation of the motor assembly 50 and generates a current signal indicating the current drawn.

The canister assembly 14 includes a canister 78 that is couplable to the pump housing 26 (e.g., by threaded connection, a bayonet-style connection, or the like). The canister assembly 14 also includes a piston 82 and rod 86 movably (e.g., slidably) supported in the canister 78. A spring 90 engaging a distal end 94 of the canister 78 biases the piston 82 and rod 86 from a first position P1 along a canister axis 98 toward a second position P2 adjacent the pump housing 26 to expel the grease stored in the canister 78 to the pump assembly 58. The canister 78 and the piston 82 define an interior 102 having a variable volume depending on the position of the piston 82 in the canister 78 relative to the pump housing 26. The variable volume is a maximum volume when the piston 82 is at the first position P1. The variable volume is a minimum volume when the piston 82 is at the second position P2, corresponding to canister 78 being emptied (or nearly emptied) of grease.

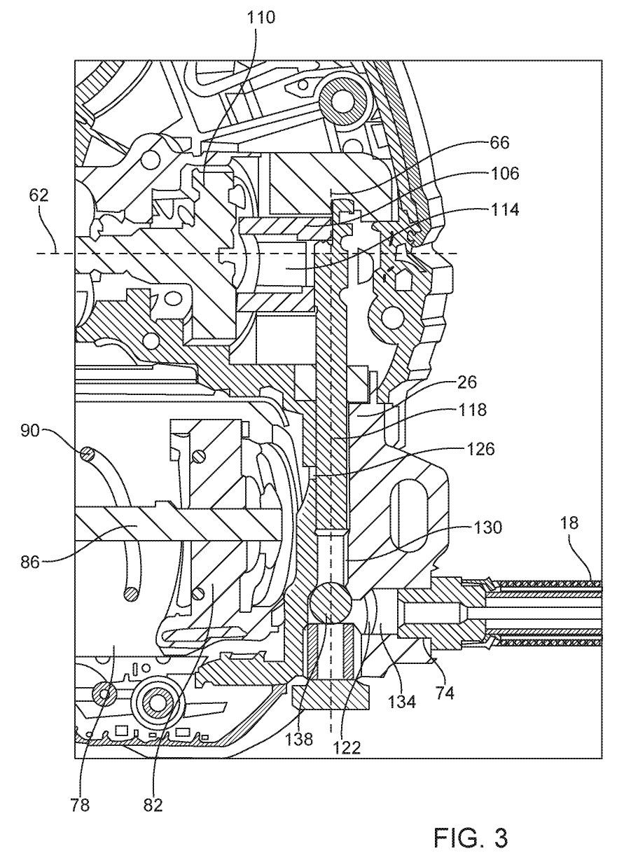

With reference to FIG. 3, the illustrated pump assembly 58 includes a yoke 106 coupled with the output 110 of the gear assembly 54. The yoke 106 includes a slot 114 that receives a lobe (not shown) of the output 110 that is offset from the rotation axis 62. The lobe is movable within the slot 114. Rotation about the rotation axis 62 of the output 110 and lobe from the top dead center to the bottom dead center positions of rotation causes reciprocation of the yoke 106, which is constrained to reciprocate in a vertical (as shown in FIG. 3) direction, between top dead center and bottom dead center positions. A plunger 118 is coupled to the yoke 106 and is supported at least partially within the pump housing 26. The plunger 118 translates between top dead center and bottom dead center positions along with the yoke 106. In other embodiments, the pump assembly 58 may have other configurations, such as a cam and follower mechanism, bevel gears, and the like, to transmit rotation of the lobe to reciprocation of the plunger 118.

With continued reference to FIG. 3, the pump housing 26 includes a discharge path 122 that communicates the interior 102 of the canister 78 with the outlet 74 to dispense grease through the hose 18. The discharge path 122 includes an inlet portion 126, a pumping portion 130 downstream of the inlet portion 126, and an outlet portion 134 downstream of the pumping portion 130. The plunger 118 reciprocates in the pumping portion 130 along the pump axis 66, which is defined by the pumping portion 130. A check valve 138 is at least partially positioned in the discharge path 122 downstream of the plunger 118, separating the pumping portion 130 and the outlet portion 134. The check valve 138 inhibits grease from flowing back into the canister 78 through pumping portion 130 and inlet portion 126.

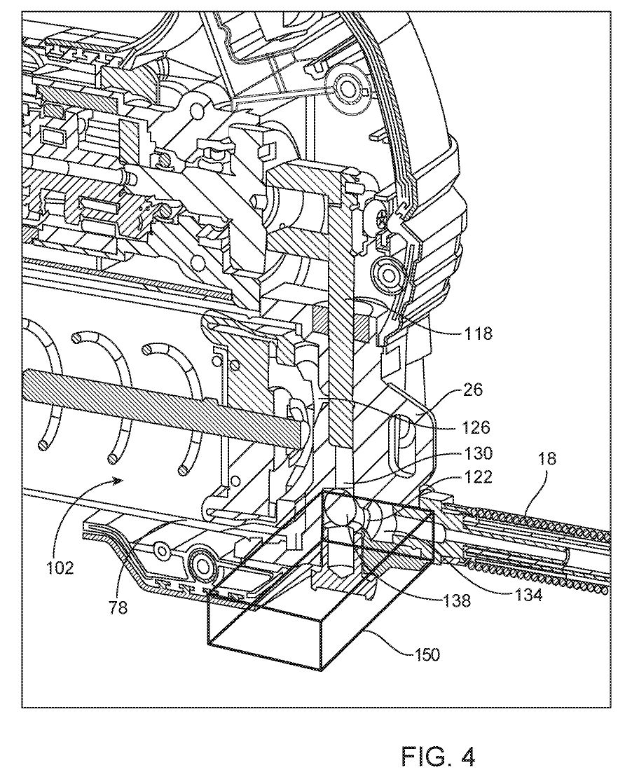

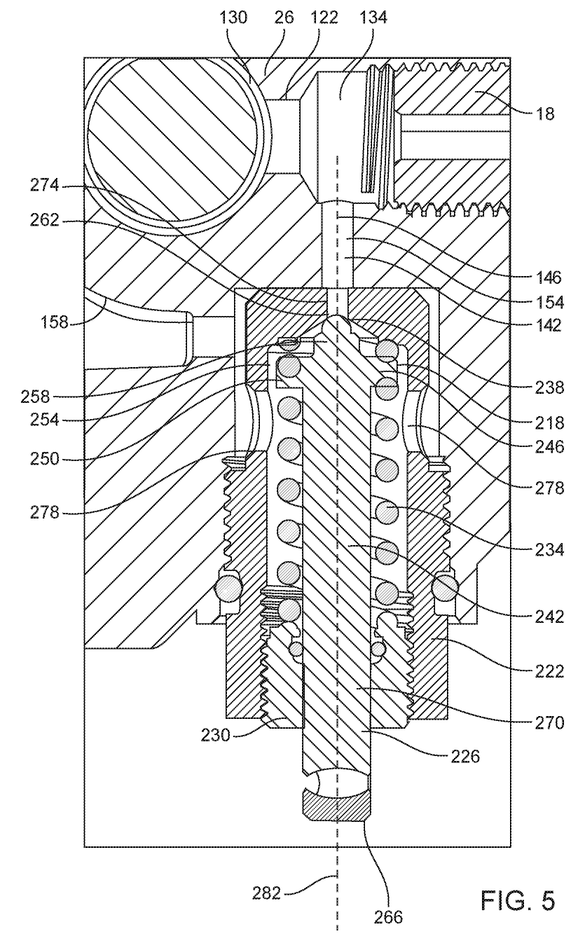

With reference to FIGS. 4 and 5, the pump housing 26 also defines a relief path 142. The relief path 142 has an inlet 146 positioned downstream of the check valve 138. The relief path 142 communicates the outlet portion 134 with the interior 102 (FIG. 4) of the canister 78, bypassing the check valve 138 and thereby allowing grease to return to the canister 78. A relief valve 150 (illustrated schematically in FIG. 4; exemplary embodiments of relief valves 218, 318 are shown in FIGS. 5-9) is at least partially supported in and defines the relief path 142. The relief path 142 includes an inlet portion 154 that extends from the inlet 146 and an outlet portion 158 in fluid communication with the interior 102 of the canister 78. The relief valve 150 is positioned between the inlet portion 154 and outlet portion 158.

With continued reference to FIG. 5, a first embodiment of a relief valve 218 is shown. The relief valve 218 includes a valve body 222 that is coupled to the pump housing 26. A valve core 226 is partially disposed in the valve body 222. The valve core 226 is movably (e.g., slidably) supported by a stopper 230 coupled to the valve body 222. A spring 234 is positioned in the valve body 222 and engages the valve core 226 and the stopper 230 to bias the valve core 226 into contact with a valve seat 238 of the valve body 222, defining the closed position of the relief valve 218. The illustrated valve core 226 includes a stem portion 242 and a flange 246 that extends radially outward from the stem portion 242. The flange 246 has an outer diameter 250 that is smaller than an inner diameter 254 of the valve body 222. A first end 258 of the stem portion 242 includes a tip 262 that is engageable with the valve seat 238. A second end 266 of the stem portion 242 extends through a hole 270 in the stopper 230 to the exterior of the valve body 222. A ring, or other type of handle, may be coupled to the second end 266 of the stem portion 242. The valve body 222 includes a valve inlet 274 that partially defines the relief path 142 and fluidly communicates the inlet portion 154 of the relief path 142 in the pump housing 26. The valve body 222 also includes one of more valve outlets 278 through which grease can flow to the outlet portion 158 of the relief path 142 in the pump housing 26. In the illustrated embodiment, the valve body 222 includes two valve outlets 278. In other embodiments, the valve body 222 may include a single valve outlet 278 or may include more than two valve outlets 278.

The valve core 226 is movable (e.g., translatable) along a valve core axis 282 defined by the stem portion 242 between a closed position (shown in FIG. 4) and an open position. In the closed position, the tip 262 engages the valve seat 238, closing the valve inlet 274 and inhibiting grease from flowing from the outlet portion 134 of the discharge path 122 to the canister 78. In the open position, the tip 262 is spaced from the valve seat 238 permitting the flow of grease from the discharge path 122 to the canister 78 (FIG. 3). In the illustrated embodiment, the valve core 226 is biased to the closed position by the spring 234. The valve core 226 is movable against the bias of the spring 234 to the open position.

The relief valve 218 is operable in a first mode (automatic mode) and a second mode (manual mode). In the first mode, the relief valve 218 opens automatically when the pressure within the outlet portion 134 of the discharge path 122exceeds a pressure threshold (e.g., 10,000 psi). The pressure overcomes the bias of the spring 234 and pushes the valve core 226 along the valve core axis 282, opening the relief valve 218 and allowing grease to return to the canister 78. In the second mode, the valve core 226 is manually actuated by a user by pulling on the stem portion 242 to overcome the bias of the spring 234, opening the valve inlet 274 and permitting grease to flow to the canister 78 (FIG. 3). For example, the user may pull on the ring or other type of handle coupled to second end 266 of the stem portion 242. The user may manually actuate the valve core 226 at any pressure, particularly any pressure below the pressure threshold. By releasing the stem portion 242, the relief valve 218 is closed (via the spring 234) to allow continued dispensing of grease. In other embodiments, actuation (i.e., opening) of the relief valve 218 may be accomplished by a solenoid or other actuator coupled to the valve core 226 that is activated by the user or in response to a parameter of tool operation.

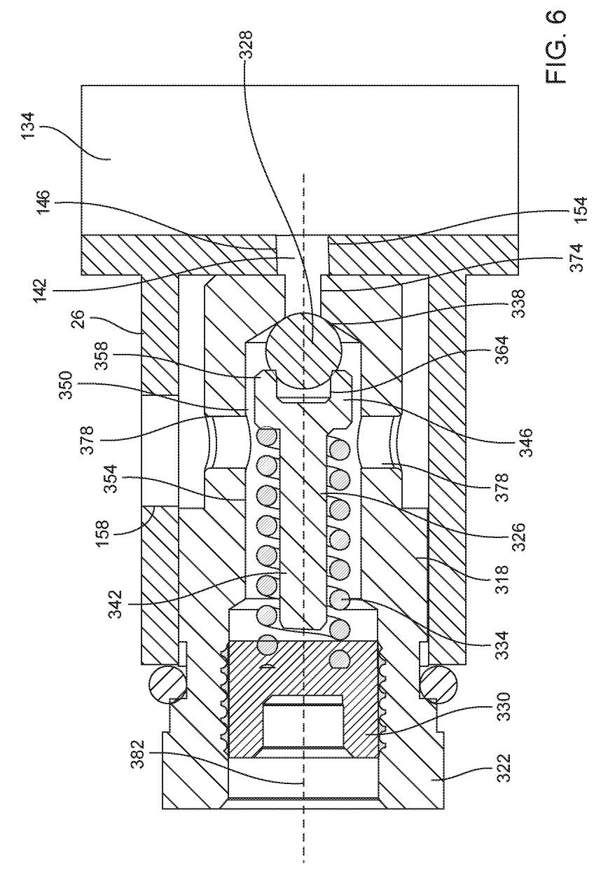

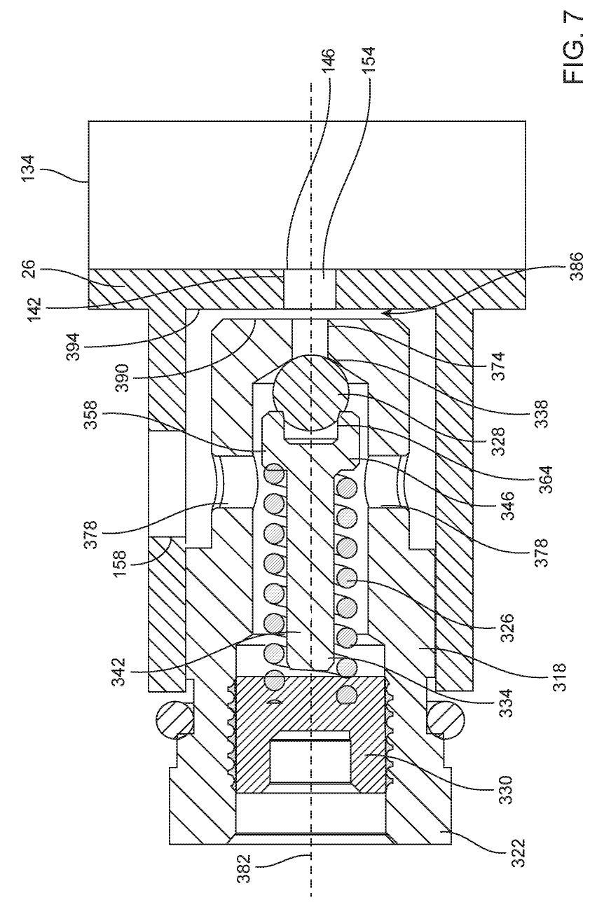

FIGS. 6 and 7 illustrate a relief valve 318 according to another embodiment. The relief valve 318 may be incorporated into the grease gun 10 described above as an alternative to the relief valve 218. Features and elements of the relief valve 318 corresponding to features and elements of the relief valve 218 described above are given similar reference numerals plus 100.

The relief valve 318 includes a valve body 322 that is coupled to the pump housing 26 and movable (e.g., rotatable) about a valve axis 382. A valve core 326 and a valve ball 328 are disposed in the valve body 322. The valve core 326 and the valve ball 328 are maintained within the valve body 322 by a stopper 330. The valve core 326 is movable (e.g., translatable) within the valve body 322. A spring 334 is also positioned in the valve body 322. The spring 334 engages the valve core 326 to bias the valve core 226 toward the valve inlet 374 and urge the valve ball 328 into contact with a valve seat 338 of the valve body 322, defining the closed position of the relief valve 318. The illustrated valve core 326 includes a stem portion 342 and a flange 346 that extends radially outward from the stem portion 342. The spring 334 surrounds the stem portion 342. The flange 346 has an outer diameter 350 that is smaller than an inner diameter 354 of the valve body 322. A first end 358 of the stem portion 342 includes a recess 364 in which the valve ball 328 is seated. The valve body 322 includes a valve inlet 374. The valve inlet 374 partially defines the relief path 142 and fluidly communicates the inlet portion 154 of the relief path 142 in the pump housing 26. The valve body 322 also includes one of more valve outlets 378 (through which grease can flow to the outlet portion 158 of the relief path 142 in the pump housing 26). In the illustrated embodiment, the valve body 322 includes two valve outlets 378. In other embodiments, the valve body 322 may include a single valve outlet 378 or may include more than two valve outlets 378.

The valve core 326 is movable (e.g., translatable) along the valve axis 382 defined by the stem portion 342 between a closed position (shown in FIG. 6) and an open position. In the closed position, the valve ball 328 engages the valve seat 338, closing the valve inlet 374 and inhibiting grease from flowing from the outlet portion 134 of the discharge path 122 to the canister 78. In the open position, the valve ball 328 is not engaged with the valve seat 338, permitting the flow of grease from the discharge path 122 to the canister 78.

With reference to FIG. 7, the valve body 322 is also movable (e.g., rotatable) about the valve axis 382 (e.g., in a 180° range) between the closed position shown in FIG. 6 and another open position shown in FIG. 7. When the valve body 322 is rotated to the open position, a gap 386 is opened between the end 390 of the valve body 322 and a wall 394 of the pump housing 26. The gap 386 permits the flow of grease from the discharge path 122 to the canister 78 without moving the valve ball 328 away from the valve seat 338. As such, the open position shown in FIG. 7 may be considered a maintained open position, while the open position achieved by moving the valve ball 328 away from the valve seat 338 may be considered a transient open position.

The relief valve 318 is operable in a first mode (automatic mode) and a second mode (manual mode). In the first mode, the relief valve 318 opens automatically when the pressure within the outlet portion 134 of the discharge path 122 exceeds a pressure threshold (e.g., 10,000 psi). The pressure overcomes the bias of the spring 334 and pushes the valve core 326 and valve ball 328 along the valve axis 382 away from the valve seat 338, opening the relief valve 318 and allowing grease to return to the canister 78. In the second mode, valve body 322 is manually actuated by a user by rotating the valve body 322 about the valve axis 382. By rotating the valve body 322 to the open position shown in FIG. 7, the gap 386 is opened, opening the valve inlet 374 and permitting grease to flow to the canister 78. The user may manually actuate the valve body 322 at any pressure, particularly any pressure below the pressure threshold. By rotating the valve body 322 in the opposite direction, the relief valve 318 is closeable to direct grease to the hose 18 again.

Returning to FIG. 1, the grease gun 10 may be operable at multiple speeds. For example, the grease gun 10 may be operable at first and second speeds, i.e., a high speed mode and low speed mode. In other embodiments, the grease gun 10 may be operable at more than two speeds (or modes). To change an operating speed (or mode) of the grease gun 10, the motor assembly 50 and/or the gear assembly 54 may be adjusted. In one embodiment, the speed of the motor assembly 50 is electronically changeable. In another embodiment, the gear assembly 54 is a multi-stage transmission, such as a planetary transmission, that can be toggled between multiple gear ratios. The illustrated grease gun includes a mode select interface 46 to change the operating speed (or mode) of the grease gun 10. In the illustrated embodiment, the mode select interface 46 is a mechanical switch 398 (FIG. 2) coupled to the gear assembly 54 and operable to change the output gear ratio of the gear assembly 54. In other embodiments, the mode select interface 46 may include a different type of actuator, such as a rotatable dial, a push button, or the like, or the mode select interface 46 may include an electrical switch that receives a signal from a user interface or a remote device to change the operating speed (or mode) of the grease gun 10.

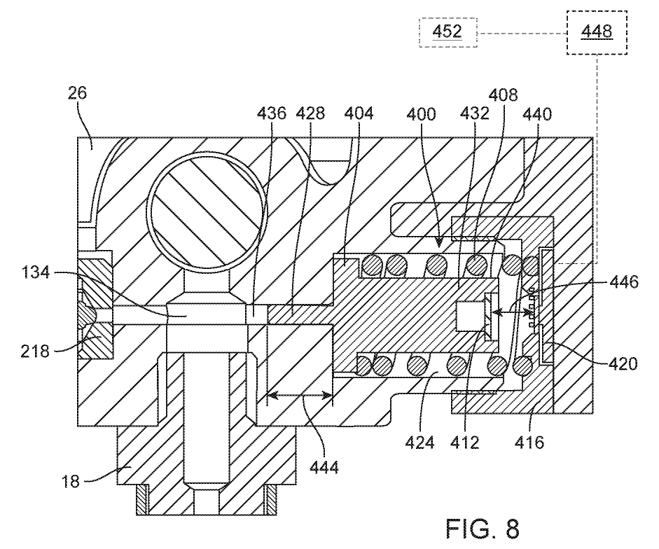

With reference to FIG. 8, the grease gun 10 also includes a pressure-sensing mechanism 400 for detecting pressure in the outlet portion 134 of the discharge path 122 (e.g., a high-pressure chamber). The illustrated pressure-sensing mechanism 400 includes a core 404 biased by a spring 408, a magnet 412 coupled to the core 404, and a cap 416 including a sensor 420 (e.g., a Hall sensor). The core 404 is slidably supported in a sensing bore 424 defined in the pump housing 26. The cap 416 is threadedly engaged with the pump housing 26 and maintains the core 404 and spring 408 in the sensing bore 424.

The core 404 includes a pin 428 extending from the body 432 of the core 404 along a channel 436 of the sensing bore 424. The channel 436 is in fluid communication with the outlet portion 134 of the discharge path 122. The magnet 412 is coupled to the body 432 at an opposite end 440 from the pin 428. The spring 408 biases the core 404 away from the cap 416, and thereby, biases the pin 428 into the channel 436 to a maximum depth 444, shown in FIG. 8. The sensor 420 senses the position of the magnet 412 and outputs a signal to a controller 448 that is indicative of the position of the magnet 412. The controller 448 may be the same controller as the controller 104, or another controller. When the pressure of the grease in the outlet portion 134 increases, the pressure acts on (e.g., pushes) the pin 428 and the body 432 against the bias of the spring 408, and thereby, moves the magnet 412 closer to the sensor 420, changing the distance 446 between the magnet 412 and sensor 420, indicating an increase in the pressure of the grease in the outlet portion 134. As the distance 446 between the magnet 412 and sensor 420 changes in relation to the pressure of the grease in the outlet portion 134, the output signal provided by the sensor 420 to the controller 448 changes.

In the present embodiment, when the grease gun 10 is operated in the high-speed mode (e.g., the grease gun is operated at the first speed), the pressure-sensing mechanism 400 is enabled. That is, the controller 448 controls operation of the grease gun based on the output signal provided by the sensor 420. As pressure increases in the outlet portion 134, a force is applied by the grease to the core 404 and moves the core 404 and magnet 412 along the sensing bore 424 toward the cap 416 and the sensor 420. When the position of the magnet 412 reaches a position that indicates the pressure in the outlet portion 134 exceeds a threshold pressure, the sensor 420 outputs a signal to the controller 448, indicating the pressure in the outlet portion 134 exceeds the threshold pressure. The threshold pressure may be, for example, 5000 psi. In other embodiments, the threshold pressure may be higher or lower. The controller 448 may then disable operation of the grease gun. In other embodiments, the controller 448 may carry out another protective operation. For example, the controller 448 may reduce the operating speed of the grease gun 10 and/or notify a user of the high-pressure condition. In some embodiments, the cap 416 may be adjusted (e.g., by threading/unthreading the cap 416 from the pump housing 26). Adjustment of the cap 416 provides for calibration or changing of the threshold pressure. In other embodiments, the pressure-sensing mechanism 400 may be enabled for both high speed and low speed modes (e.g., first and second speeds). In still other embodiments, the output signal from the sensor 420 may be used to detect back-pressure at all pressures. In still other embodiments, the grease gun 10 may include a light emitting diode 452 coupled to the housing 22. The LED 452 may indicate when the pressure has exceeded a predetermined value (e.g., the pressure threshold). The LED 452 may be activated by the controller 448. In other embodiments, the grease gun may include another indicator instead of an LED.

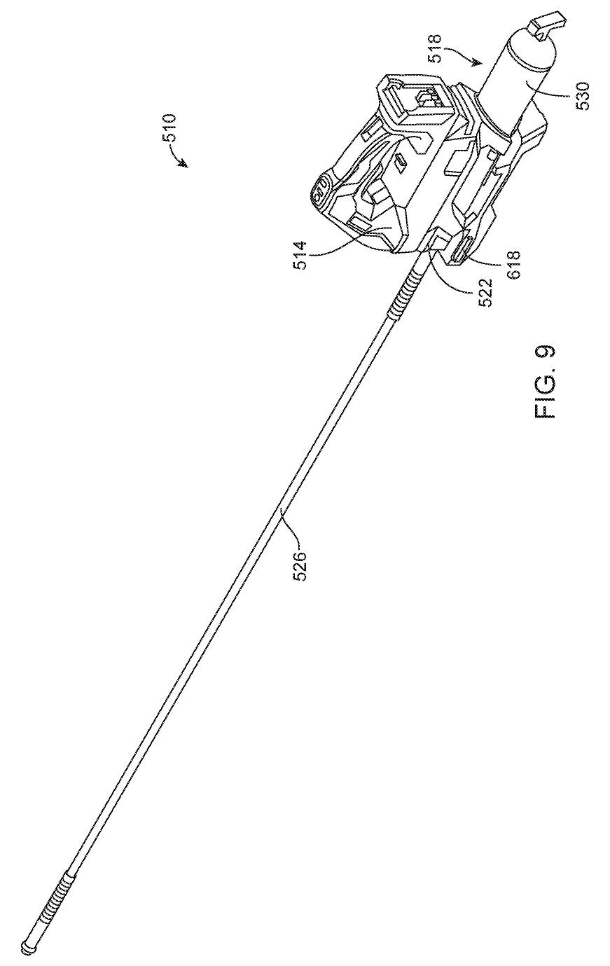

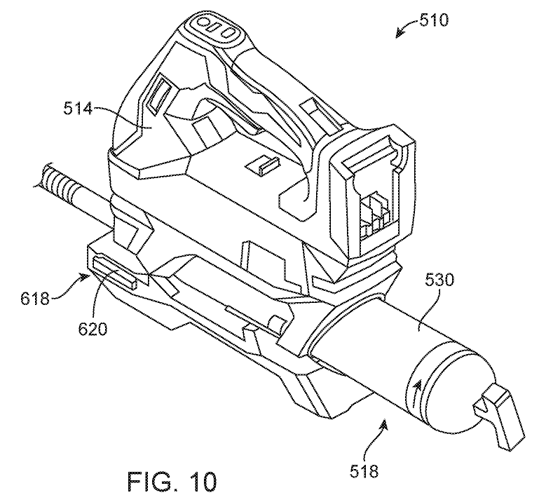

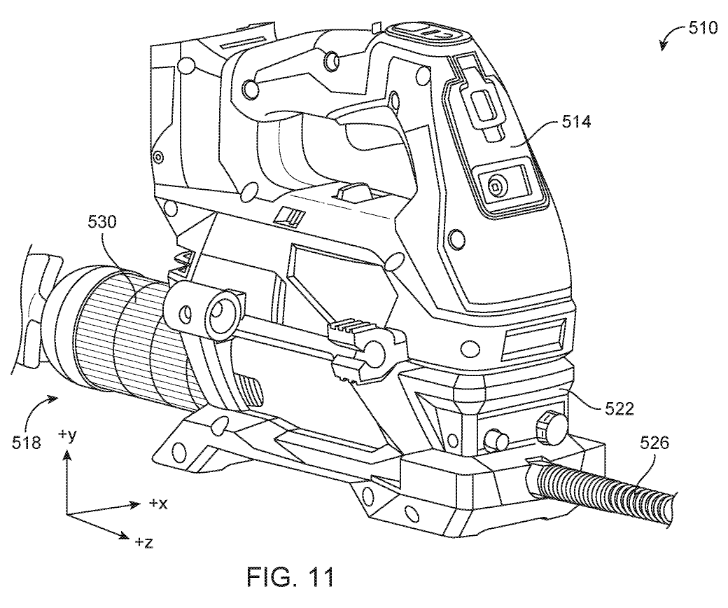

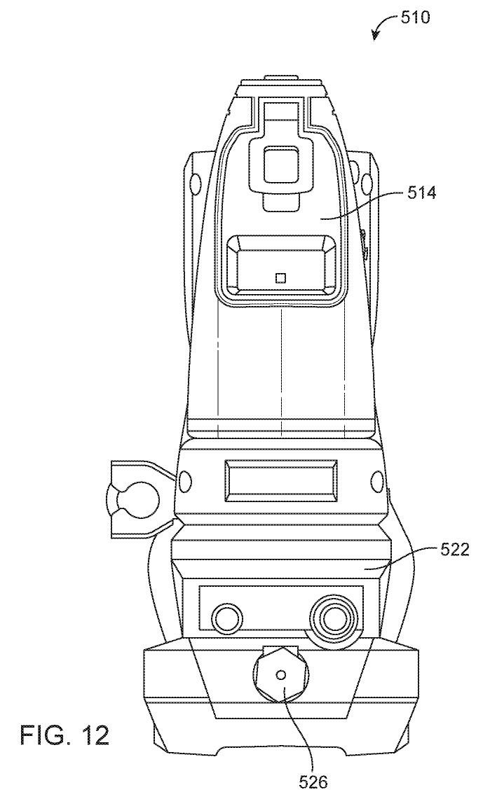

FIGS. 9-12 illustrate another grease gun 510. The grease gun 10 is similar to the grease gun 10 described above. Reference is made to the description of the grease gun 10 for description of features, elements, operations, and alternatives of the grease gun 510 not explicitly described below.

Similar to the grease gun 10, the illustrated grease gun 510 includes a housing 514 that supports a motor assembly, a gear assembly, and a pump assembly. The grease gun 510 also includes a canister assembly 518 coupled to a pump housing 522 that is supported by the housing 514, and a hose 526 that is coupled to an outlet of the pump housing 522. The canister assembly 518 includes a canister 530 that is couplable to the pump housing 522.

As shown in FIG. 9, the grease gun 510 also includes a relief valve 618. The relief valve 618 is positioned on a side of the housing 514, adjacent the pump housing 522 and the hose 526. In the illustrated embodiment, the relief valve 618 includes a lever 620 to facilitate manual actuation of the relief valve 618.

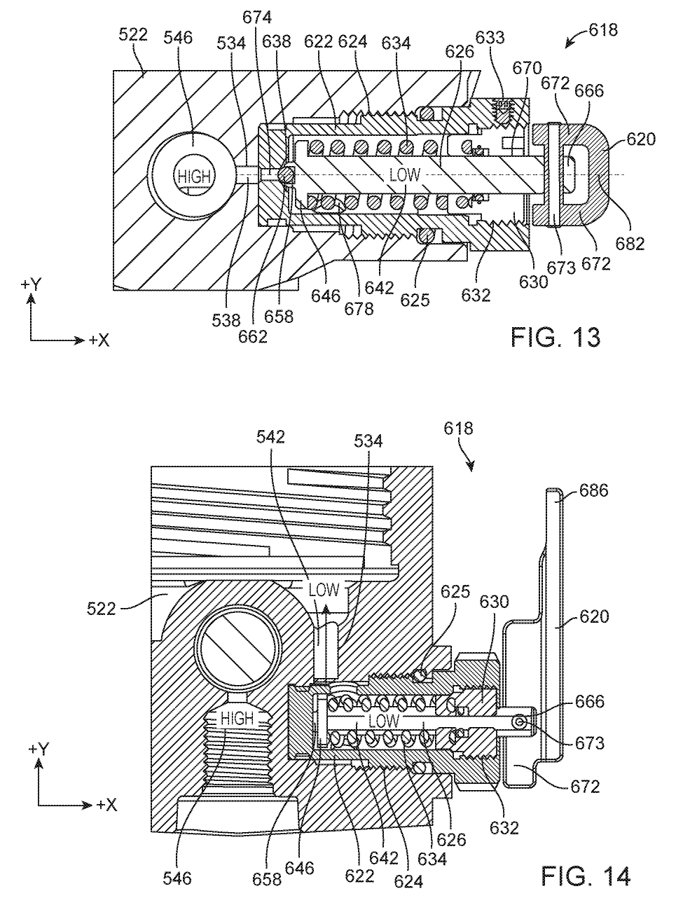

As shown in FIGS. 13 and 14, the relief valve 618 also includes a valve body 622 that is coupled to the pump housing 522. The valve body 622 is threadably coupled to the pump housing 522 by threads 624. The valve body 622 supports the other components of the relief valve 618 such that the relief valve 618 can be coupled to and removed from the pump housing 522 as a single unit. A seal 625 is positioned between the valve body 622 and the pump housing 522, exterior to the threads 624.

A valve core 626 is partially disposed in the valve body 622. The valve core 626 is movably (e.g., slidably) supported by a stopper 630 coupled to the valve body 622. The stopper 630 is threadably coupled to the valve body 622 by threads 632. The threads 632 allow a position of the stopper 630 to be adjusted to calibrate the relief valve 618 during assembly or by an end user. A fastener 633 (e.g., a set screw) extends through the valve body 622 and engages the stopper 630 to secure the stopper 630 in place. In the illustrated embodiment, the fastener 633 engages the threads 632 of the stopper 630. A spring 634 is positioned in the valve body 622 and engages the valve core 626 and the stopper 630 to bias the valve core 626 into contact with a valve seat 638 of the valve body 622, defining a closed position of the relief valve 618. The illustrated valve core 626 includes a stem portion 642 and a flange 646 that extends radially outward from the stem portion 642. The flange 646 has an outer diameter that is smaller than an inner diameter of the valve body 622. A first end 658 of the stem portion 642 includes a tip 662 that is engageable with the valve seat 638. A second end 666 of the stem portion 642 extends through a hole 670 in the stopper 630 to the exterior of the valve body 622. The lever 620 is coupled to the second end 666 of the stem portion 642. The illustrated lever 620 has a U-shaped cross-section, and the second end 666 of the stem portion 642 is received between opposing walls 672 of the lever 620. A pin 673 extends through the opposing walls 672 of the lever 620 and the second end 666 of the stem portion 642 to couple them together. The valve body 622 includes a valve inlet 674 that partially defines a relief path 534 of the pump housing 522 and fluidly communicates with an inlet portion 538 of the relief path 534 in the pump housing 522. The valve body 622 also includes one of more valve outlets 678 through which grease can flow to an outlet portion 542 of the relief path 534 in the pump housing 522.

The valve core 626 is movable (e.g., translatable) along a valve core axis 682 defined by the stem portion 642 between a closed position (as illustrated) and an open position. In the closed position, the tip 662 engages the valve seat 638, closing the valve inlet 674 and inhibiting grease from flowing from a discharge path 546 of the pump housing 522 to the canister 530. In the open position, the tip 662 is spaced from the valve seat 638, permitting the flow of grease from the discharge path 546 to the canister 530. In the illustrated embodiment, the valve core 626 is biased to the closed position by the spring 634. The valve core 626 is movable against the bias of the spring 634 to the open position.

The relief valve 618 is operable in a first mode (automatic mode) and a second mode (manual mode). In the first mode, the relief valve 618 opens automatically when the pressure within the discharge path exceeds a pressure threshold (e.g., 10,000 psi). The pressure overcomes the bias of the spring 634 and pushes the valve core 626 along the valve core axis 682, opening the relief valve 618 and allowing grease to return to the canister 530. In the second mode, the valve core 626 is manually actuated by a user operating the lever 620 to overcome the bias of the spring 634, opening the valve inlet 674 and permitting grease to flow to the canister 530. In the illustrated embodiment, the user pulls a distal or free end 686 of the lever 620 (opposite from the stem portion 642) away from the housing 514 to operate the lever 620 and open the relief valve 618. In other embodiments, the user may push the distal or free end 686 of the lever 620 toward the housing 514 to operate the lever 620 and open the relief valve 618. The user may manually actuate the valve core 626 via the lever 620 at any pressure, particularly any pressure below the pressure threshold. By releasing the lever 620, the relief valve 618 is closed (via the spring 634) to allow continued dispensing of grease.

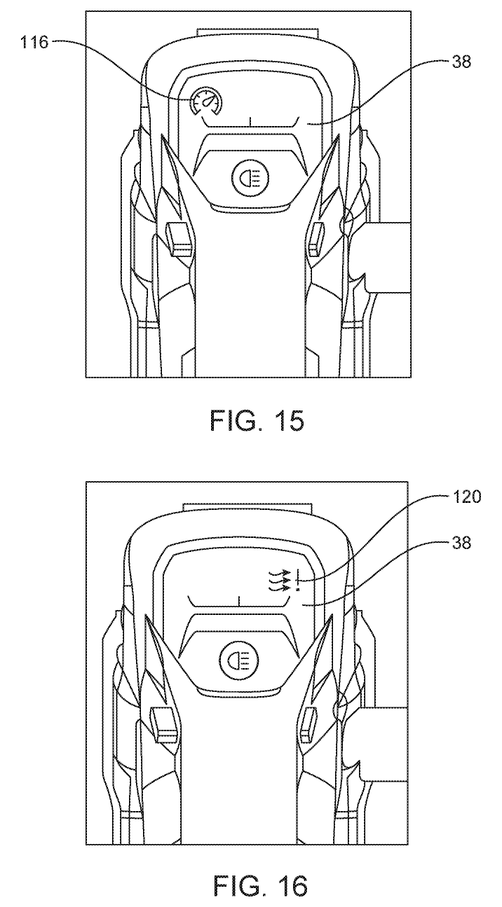

With reference to FIGS. 15 and 16, the display unit 38 includes two indicator lights 116, 120. In other embodiments, the display unit 38 may include fewer or more indicator lights. The first indicator light 116 is configured to indicate a build-up of pressure in the grease gun 10. For example, the first indicator light 116 may display a dial image with an arrow. The pressure build-up indication provided by the first indicator light 116 is provided when the pressure within the grease gun 10 has reached an initial operational pressure threshold Pᵢ that is below the low-pressure threshold P_{L} (e.g., 1,000 psi). The initial operational pressure threshold Pᵢ may be settable. The pressure build-up indication provides a visual reminder to a user to relieve pressure (e.g., by manual actuation of the pressure relief valve 150) before disconnecting the hose 18 from an external fitting or zerk. The second indicator light 120 is configured to indicate that a pressure threshold (the low-pressure threshold P_{L} or the high-pressure threshold P_{H}) has been met and that the grease gun 10 may be subject to one or more protective measures, depending on the mode of operation. For example, the second indicator light 120 may display an image of arrows pointing to an exclamation mark. In other embodiments, the first and second indicator lights 116, 120 may display other images, graphics, icons, colors, etc.

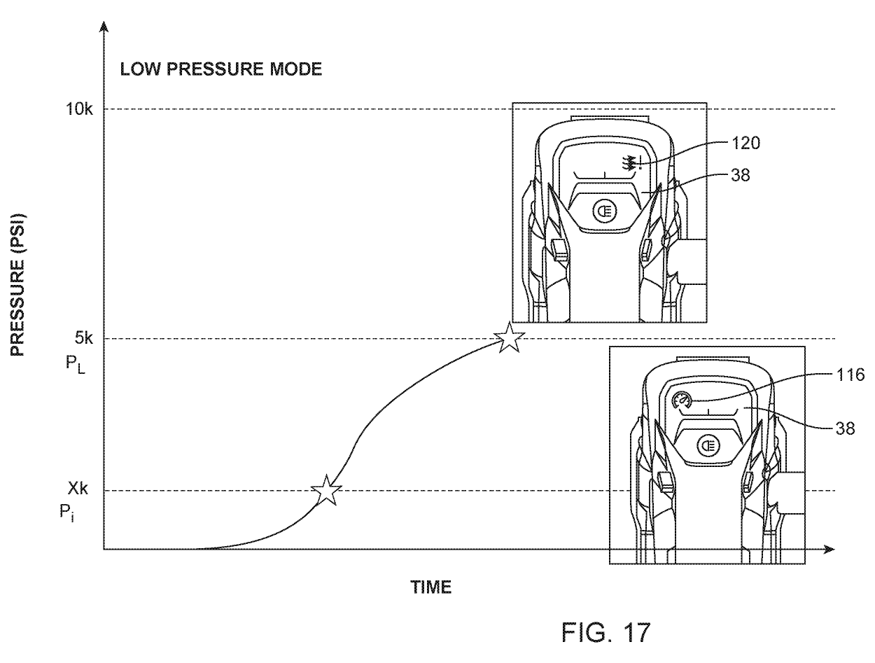

FIG. 17 illustrates operation of the grease gun in the first, low-pressure mode having a low-pressure threshold P_{L} (e.g., 5,000 psi). With reference to FIGS. 1, 2, and 17, in the low-pressure mode, operation of the trigger 30 by the user energizes the motor assembly 50 to impart a rotational output to the gear assembly 54 and pump assembly 58 to pump grease from the canister assembly 14. The controller 104 receives the mode signal, current signal, and pressure signal and monitors the condition of the grease gun 10 as the grease gun operates. When the pressure sensed by the pressure sensing mechanism 400 reaches the initial operational pressure threshold Pᵢ, indicated by the pressure signal received by the controller 104, the controller 104 provides an indicator signal to the display unit 38 to illuminate the first indicator light 116 to indicate to the user that pressure is increasing in the grease gun 10. When the pressure in the discharge path 122 reaches the low-pressure threshold P_{L}, as measured by the pressure sensing mechanism 400, the controller 104, in response to the pressure signal received from the pressure sensing mechanism 400 provides an indicator signal to the display unit 38 to illuminate the second indicator light 120 to indicate the low-pressure threshold P_{L} for the low-pressure mode has been reached. The controller 104 also performs a protective operation, such as disabling the motor assembly 50 to inhibit the pressure in the discharge path 122 from increasing above the low-pressure threshold P_{L}.

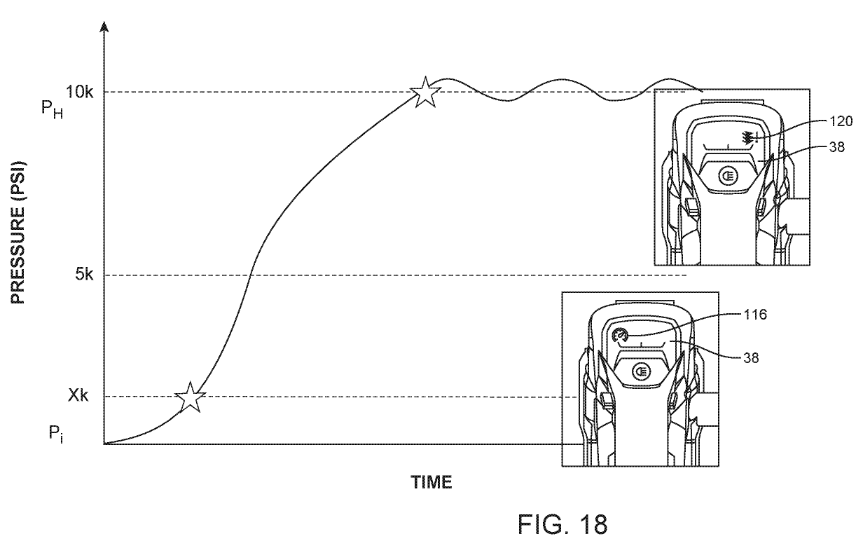

FIG. 18 illustrates operation of the grease gun 10 in the second, high-pressure mode having a high-pressure threshold P_{H} (e.g., 10,000 psi) that is higher than the low-pressure threshold P_{L}. In the high-pressure mode, operation of the trigger 30 by the user energizes the motor assembly 50 to impart a rotational output to the gear assembly 54 and pump assembly 58 to pump grease from the canister assembly 14. The controller 104 receives the mode signal, current signal, and pressure signal and monitors the condition of the grease gun 10 as the grease gun 10 operates. In the high-pressure mode, the current drawn by the motor assembly 50 is used as a proxy for the pressure in the discharge path 122. As the pressure in the discharge path 122 increases and the motor current increases in a corresponding manner such that the current drawn by the motor assembly 50 indicates the pressure in the discharge path 122 has reached the initial operational pressure threshold Pᵢ, the current signal is provided by the current sensor 112 to the controller 104, and the controller 104 provides an indicator signal to the display unit 38 to illuminate the first indicator light 116 to indicate to the user that pressure is increasing in the grease gun 10. When the pressure in the discharge path 122, as indicated by the current draw of the motor assembly 50 sensed by the current sensor 112 reaches the high-pressure threshold P_{H}, the controller 104 provides an indicator signal to the display unit 38 to illuminate the second indicator light 120 to indicate the high-pressure threshold P_{H} for the high-pressure mode has been reached. The high-pressure threshold P_{H} is the same pressure as the pressure at which the pressure relief valve 150 is automatically openable. As the pressure reaches the high-pressure threshold P_{H}, the pressure relief valve 150 opens, allowing grease to flow back to the canister assembly 14 through the relief path 142. The pressure in the discharge path 122 drops while the pressure relief valve 150 is open and grease returns to the canister assembly 14. Once the pressure relief valve 150 closes, the pressure in the discharge path 122 increases to the high-pressure threshold again. The pressure in the discharge path 122 continues to cycle as the pressure relief valve 150 opens and closes until grease gun operation ceases. The second indicator light 120 remains illuminated when the pressure, as indicated by motor current, reaches the high-pressure threshold P_{H} the first time.

As described above, the controller 104 controls operation of the grease gun 10 using a different signal for each of the low-pressure and high-pressure modes. In the low-pressure mode, the controller 104 controls operation of the grease gun 10 based on the pressure signal provided by the pressure sensing mechanism 400. In the high-pressure mode, the controller 104 controls operation of the grease gun 10 based on the current signal provided by the current sensor 112, as a proxy for the pressure value. As pressure in the discharge path 122 increases, the current drawn by the motor assembly 50 increases in correlation to the increase in pressure in the discharge path 122.

Use of binary sensors, that is, a current sensor 112 to measure current drawn by the motor assembly 50 and a pressure sensing mechanism 400 to measure the pressure of the grease in the discharge path 122, is advantageous as a cost-effective and reliable method of monitoring conditions of the grease gun 10. It will be appreciated that motor-driven tools often include a current sensor 112 for monitoring tool conditions and controlling the operation of grease gun 10 based on the current value would simply be a matter of using the current signal from the current sensor 112 for controlling grease gun operation. Furthermore, using the pressure sensing mechanism 400 in parallel with the current sensor 112 allows the pressure sensing mechanism 400 to be calibrated for, and therefore provide better resolution around, a specific pressure value, instead of using the pressure sensing mechanism 400 for a wide range of pressure values. Further still, in the present embodiment, using the pressure sensing mechanism 400 at the lower pressure threshold is advantageous as the pressure sensing mechanism 400 provides better resolution, and is therefore more accurate, at a pressure that is unprotected by a pressure relief valve 150. Accurate measurement and grease gun control is important to inhibit the grease gun from exceeding the low-pressure threshold to inhibit over-pressurized grease from being dispensed to a fitting or zerk.

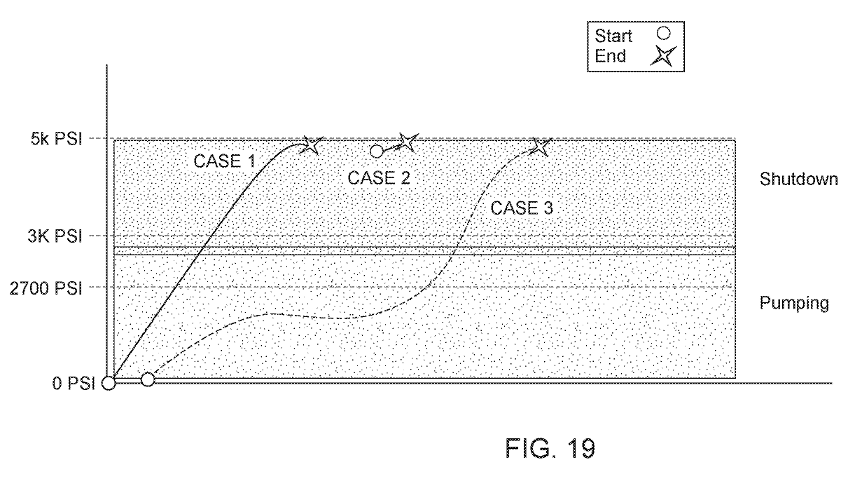

FIGS. 19-24 illustrate other embodiments of operating modes of a grease gun. In the embodiments shown in FIGS. 19-24, the operation of the grease gun is based on the current drawn by the motor assembly 50 due to the correlation of motor current with pressure. In the embodiments described, the controller 104 monitors only the current sensed by the current sensor 112.

FIG. 19 illustrates exemplary operating pressure curves (determined based on the correlation of average current drawn by the motor assembly 50 over a period of time (e.g., 10ms) to the pressure of the grease pumped from the grease gun) as a function of time. The grease gun is operable in two different modes, a first, high pressure mode and a second, high flow mode, with different operating cases in the second mode shown in FIG. 19. Based on the mode selected, a different pressure threshold is used by, for instance, the controller 104, to control operation of the grease gun. In the different operating modes, the user is alerted to different conditions.

In the first mode, the grease gun provides indications that the pressure of the grease has exceeded a first, higher, threshold (e.g., 10k psi) and that grease is recirculating to the canister. Once the first threshold pressure is met, if it remains elevated for a period of time (e.g., 3 seconds), an indicator may be activated (e.g., a blinking light). If the pressure continues to remain elevated for a further period of time (e.g., 3 seconds), a different indicator (e.g., a solid light) will activate. If the pressure drops below a threshold pressure, (e.g., indicating clearance of a clog), the indicator will be turned off.

In the second mode, the grease gun provides indications that the pressure exceeds a second, lower, threshold (e.g., 5k psi). Several different operating cases may occur in the second operating mode. In the first case, representative of a deadhead clog, the operating pressure starts at 0 psi and increases over a relatively short period of time to the pressure threshold of the grease gun (e.g., 5,000 psi). In a second case, representative of a stall condition, the pressure starts and remains at or near the threshold. In the third case, a delayed/gradual increase in pressure, the grease gun may operate in a manner similar to the first operation mode.

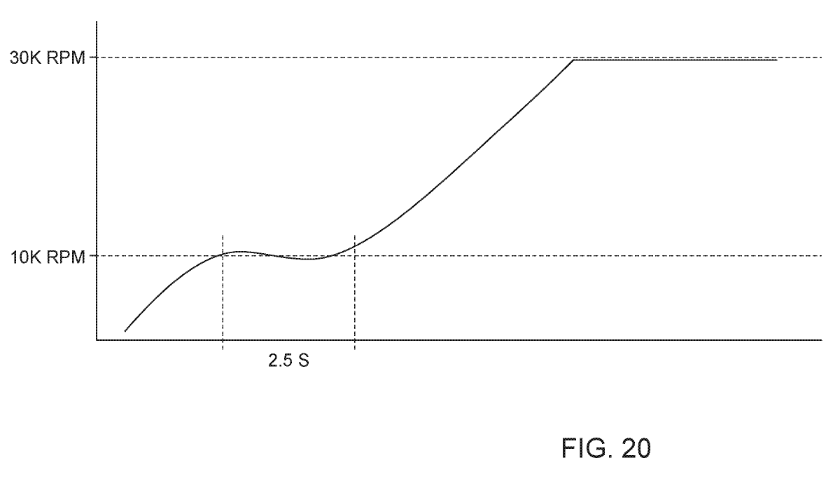

With reference to FIGS. 19 and 20, in the first and second cases, the motor assembly 50, as illustrated in the motor starting curve of motor revolutions as a function of time (FIG. 20), is started at a reduced speed for a period of time (e.g., 2.5 seconds) prior to increasing to full speed. In the third case, the motor starting curve may be substantially similar to the starting curve of the grease gun operating in the high pressure mode. For each of the operating cases for the second mode, the grease gun may shut down after reaching the second threshold.

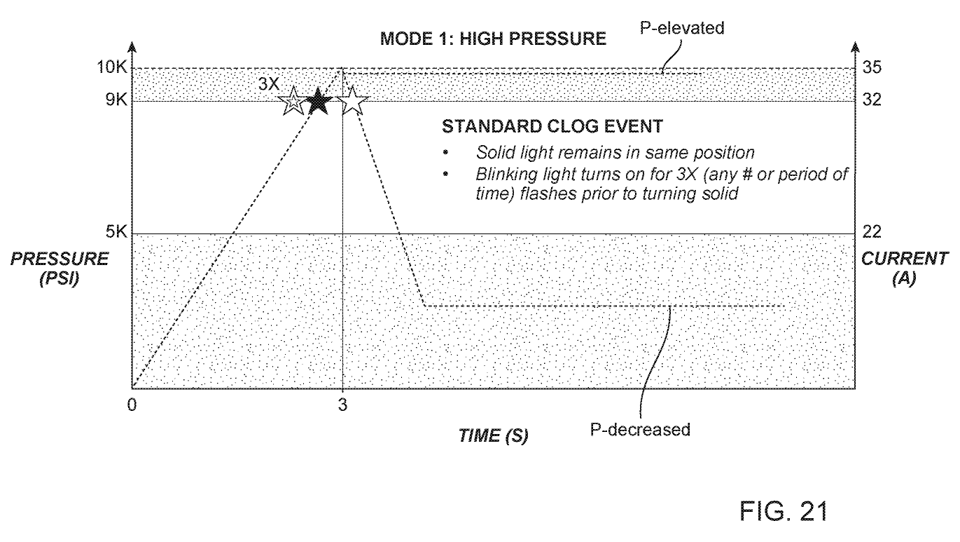

FIGS. 21-24 illustrate exemplary pressure curves as a function of time and indicators provided by the grease gun to the user.

FIG. 21 is a pressure curve for a grease gun operating in the first, high pressure mode experiencing a standard clog event. Pressure builds from 0 psi at the commencement of a grease dispensing operation (0 seconds) and increases toward the high pressure threshold (e.g., 10k psi, corresponding to a motor current of 35 amps, sensed by the current sensor 112). As the pressure approaches the threshold, at an indicating pressure below the threshold (e.g., 10% below the threshold, corresponding to a motor current of 32 amps), an indicator is activated (e.g., a blinking/flashing light). If the pressure continues to remain above the indicating pressure for a period of time, shown as “P-elevated,” the indicator will remain in a solid state (solidly illuminated). If the pressure drops below the indicating pressure, illustrated by the “P-decreased” curve, the indicator will be deactivated. In other embodiments, different currents may correspond to the thresholds, or the pressure may be measured in different ways. The thresholds may be set by the controller 104, or may be manually set by the user based on one or more operating conditions (ambient temperature, grease temperature, grease viscosity, etc.).

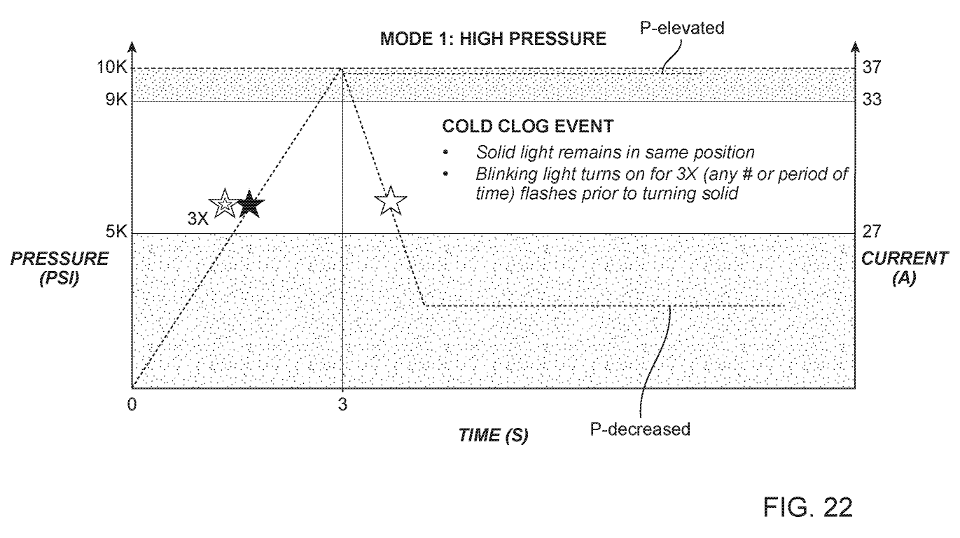

FIG. 22 is a pressure curve for a grease gun operating in the first, high pressure mode experiencing a cold clog event, i.e., when the temperature of the grease is cold, and therefore, less viscous. The controller 104 may include a temperature sensor configured to measure the ambient air temperature, or a temperature sensor may be included in the grease gun to measure a temperature of the grease. The pressure curve follows a similar path, with the difference being that an indicator is activated at a lower cold threshold (e.g., 60% of the pressure threshold), with the grease gun continuing to operate. The cold threshold may correspond to a motor current between 27 and 33 amps, for instance, 28 amps. The high-pressure threshold P_{H} may be different for cold grease, for instance, 37 amps. If the pressure curve follows the P-decreased curve, the indicator will be deactivated when the pressure falls below the cold threshold.

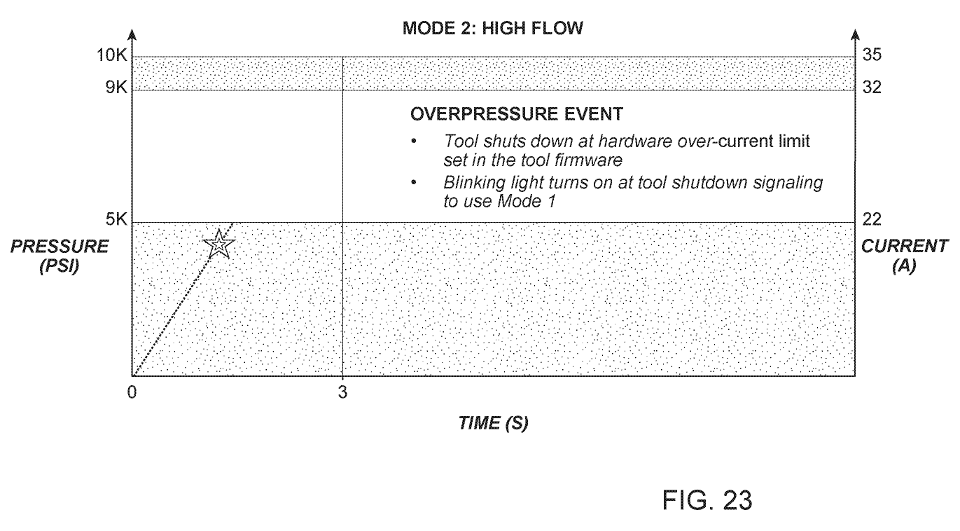

FIG. 23 is a pressure curve for a grease gun operating in the second, high speed mode and experiencing an overpressure event. Pressure increases from 0 psi at the commencement of a grease dispensing operation (0 seconds) and increases toward the low pressure threshold (e.g., 5k psi, corresponding to a motor current of 22 amps). As the pressure approaches the threshold, at an indicating pressure below the threshold (e.g., 10% below the threshold, corresponding to a motor current of 19.8 amps), an indicator is activated (e.g., a blinking light) and the grease gun is deactivated when the tool reaches the low pressure threshold. In other embodiments, a different current may correspond to the threshold, or the pressure may be measured in different ways.

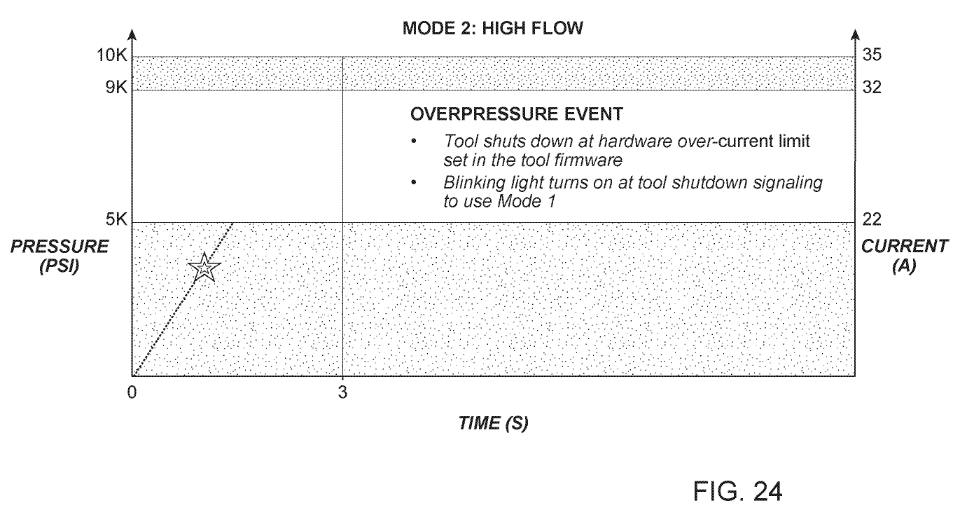

FIG. 24 is a pressure curve for a grease gun operating in the second, high speed mode and experiencing a cold overpressure event. Pressure increases from 0 psi at the commencement of a grease dispensing operation (0 seconds) and increases toward the low pressure threshold (e.g., 5k psi, corresponding to 22 amps). As the pressure approaches the threshold, at a cold threshold below the threshold (e.g., 20% below the threshold, corresponding to a motor current of 17.6 amps), an indicator is activated (e.g., a blinking light) and the grease gun is deactivated when the tool reaches the low pressure threshold.

For the pressure curves illustrated in FIGS. 23 and 24, the indicator indicates to the user that the user should operate the tool in the first, low pressure mode.

It should be understood that the pressures and currents described above may be different depending on the motor assembly, gear assembly, and pup assembly, hose size, etc.

Although the invention has been described in detail with reference to certain preferred embodiments, variations and modifications exist within the scope and spirit of one or more independent aspects of the invention as described. Various features of the invention are set forth in the following claims.

What is claimed is:

1. A grease gun configured to dispense grease, the grease gun comprising:
a housing;
a motor assembly supported in the housing;
a pump assembly driven by the motor assembly to generate a flow of grease, the pump assembly including a plunger;
a canister assembly configured to provide grease to the pump assembly, the canister assembly including a canister defining an interior in which grease is stored;
a pump housing supported by the housing and to which the canister assembly is coupled, the pump housing defining a discharge path in which the plunger is at least partially supported, the discharge path communicating the interior of the canister with an outlet of the discharge path;
a check valve at least partially supported in the discharge path downstream of the plunger; and
a relief valve at least partially defining a relief path downstream of the check valve, the relief path configured to convey grease from the discharge path to the interior of the canister, the relief valve operable in a first mode and a second mode, in the first mode the relief valve is automatically opened when a pressure in the discharge path exceeds a pressure threshold, and in the second mode, the relief valve is selectively openable to allow grease to flow from the discharge path through the relief path to the interior of the canister.

2. The grease gun of claim 1, wherein the pump housing at least partially defines the relief path, including an inlet portion in fluid communication with the discharge path and an outlet portion in fluid communication with the interior, and
wherein the relief valve includes
a valve body coupled to the pump housing, the valve body including a valve inlet in fluid communication with the inlet portion and a valve outlet in fluid communication with the outlet portion,
a valve core at least partially supported in the valve body and translatable along a valve core axis, and
a spring engaging the valve core and biasing the valve core into engagement with the valve body.

3. The grease gun of claim 2, wherein the valve core includes a stem portion that extends beyond an end of the valve body, and wherein the stem portion is engageable to translate the valve core along the valve core axis against a bias of the spring.

4. The grease gun of claim 3, wherein a lever is coupled to the stem portion and is engageable to translate the valve core.

5. The grease gun of claim 2 wherein the relief valve is selectively openable by manual actuation of the valve core by a user.

6. The grease gun of claim 2, further comprising a solenoid coupled to the valve core, the relief valve openable by activation of the solenoid.

7. The grease gun of claim 1, further comprising a pressure-sensing mechanism for detecting pressure in the discharge path.

8. A grease gun configured to expel grease, the grease gun comprising:
a housing;
a pump housing supported in the housing;
a canister coupled to the pump housing having an interior in which a quantity of grease is stored;
a motor supported in the housing;
a pump assembly at least partially supported in the pump housing, the pump assembly coupled to the motor to receive an output from the motor to pump grease from the canister through a flow path to an outlet of the pump housing;
a pressure sensor in fluid communication with the flow path, the pressure sensor configured to generate a pressure signal indicating a fluid pressure in the flow path;
a current sensor configured to measure a current drawn by the motor and generate a current signal indicating the current;
a controller configured to receive the pressure signal and the current signal and generate an indicator signal; and
a display unit coupled to the housing, the display unit including an indicator light that is illuminated based on the indicator signal.

9. The grease gun of claim 8, wherein the controller is configured to perform a protective function if the fluid pressure of the grease exceeds a pressure threshold.

10. The grease gun of claim 9, wherein the protective function is a tool shutdown.

11. The grease gun of claim 8, wherein the grease gun is selectively operable in a first mode, in which the controller generates the indicator signal based on the pressure signal, and in a second mode, in which the controller generates the indicator signal based on the current signal.

12. A grease gun configured to expel grease, the grease gun comprising:
a housing;
a pump housing supported in the housing;
a canister coupled to the pump housing having an interior in which a quantity of grease is stored;
a motor supported in the housing;
a pump assembly at least partially supported in the pump housing, the pump assembly coupled to the motor to receive an output from the motor to pump grease from the canister through a flow path to an outlet of the pump housing;
a current sensor configured to measure a current drawn by the motor and generate a current signal indicating the current, the current signal indicating a pressure of the grease;
a controller configured to operate the motor in a first mode and in a second mode, the controller generating an indicator signal based on the current signal; and
a display unit coupled to the housing, the display unit including an indicator light that is illuminated based on the indicator signal.

13. The grease gun of claim 12, wherein a maximum operating pressure of the grease gun in the first mode is greater than a maximum operating pressure of the grease gun in the second mode.

14. The grease gun of claim 13, wherein the indicator light is illuminated when the current indicates a pressure at a threshold pressure that is less than a maximum operating pressure of the grease gun.

15. The grease gun of claim 14, wherein the indicator light is deactivated when the current drops below the threshold pressure.

16. The grease gun of claim 14, wherein the indicator light is illuminated in a solid state.

17. The grease gun of claim 14, wherein the indicator light is illuminated in a flashing state at a pressure below the threshold pressure and is illuminated in a solid state when the pressure reaches the threshold pressure.

18. The grease gun of claim 14, further comprising a temperature sensor configured to measure a temperature of the grease and provide a temperature signal to the controller indicating the temperature of the grease, wherein the controller sets the threshold pressure based on the temperature of the grease.

19. The grease gun of claim 13, wherein when the grease gun is operated in the second mode, the controller performs a tool protection function when the maximum operating pressure is reached.

20. The grease gun of claim 19, wherein the tool protection function is a tool shutdown.
